(19) United States
(12) Patent Application Publication
(10) Pub. No.: US 2014/0274860 A1
(43) Pub. Date: Sep. 18, 2014

(54) SYNERGISTIC EFFECT OF SOIL RELEASE POLYMERS ON WASH PERFORMANCE OF FABRICS

(71) Applicant: The Dial Corporation, Scottsdale, AZ (US)

(72) Inventor: Jeffrey Bankers, Phoenix, AZ (US)

(21) Appl. No.: 14/353,455

(22) PCT Filed: Oct. 12, 2012
(86) PCT No.: PCT/US2012/061482

§ 371 Date: Apr. 22, 2014

Related U.S. Application Data
(60) Provisional application No. 61/552,293, filed on Oct. 27, 2011.

(51) Int. Cl. C11D 3/00

(52) U.S. Cl. CPC C11D 3/0036
USPC 510/299

(57) ABSTRACT

The present invention is a dry granular laundry detergent comprising builder, alkaline agent, filler, and surfactant, and a synergistic blend of polymeric soil release agents consisting essentially of from about 0.1 wt. % to about 0.5 wt. % nonionic soil release agent and from about 0.1 wt. % to about 1.0 wt. % anionic soil release polymer, wherein the weight ratio of nonionic agent to anionic agent is from about 1:1.5 to about 1:2.0. Using the mixture of nonionic and anionic soil release agents at the critical weight ratio of 1:1.5 to about 1:2.0 gives a synergistic boost in performance of the detergent, allowing about a 20% by weight lower dosing of dry detergent in the wash machine to achieve the same performance as a control composition not having soil release agent.

### CROSS-REFERENCE TO RELATED APPLICATIONS

The present application claims priority to U. S. Provisional Application 61/552,293 filed Oct. 27, 2011 and entitled “SYNERGISTIC EFFECT OF SOIL RELEASE POLYMERS ON WASH PERFORMANCE OF FABRICS”, which is incorporated herein.

### FIELD OF THE INVENTION

The present invention relates to granular laundry detergents and more specifically to the use of a synergistic blend of polymeric soil release agents in granular detergent compositions to increase cleaning performance.

### BACKGROUND OF THE INVENTION

It is well known that certain polymeric substances called “soil release polymers” or “soil release agents” can facilitate the removal of certain soils from cotton, polyester, and polyester/cotton blended fabrics when incorporated into laundry detergents or rinse additives such as fabric softeners. Soil release agents were initially developed for use in fabric finishing processes where the agents gave the treated polyester fibers a more hydrophilic character. Since oily soils bond very well to the hydrophobic polyester, removal of the oily soil is difficult when the soiled fabric is washed in an aqueous detergent solution. Soil release agents bind onto fabrics, providing a place for oily soils to reside before being washed off along with the soil release agent in the washing machine.

Soil release agents are ordinarily classified as polymers, or at least oligomers depending on molecular weight, and may be nonionic, anionic, cationic, or zwitterionic in overall charge. Except for the nonionic soil release agents, overall charge may depend on the pH of the composition containing the release agent and the pH of the diluted wash bath containing the detergent composition. Soil release agents have evolved to provide soil release effects to a wider variety of fabric types rather than only polyester, and to improve stability to hydrolysis and oxidation.

These inventive polymeric soil release agents are well known and some of the references disclosing these agents are reviewed below.

The earliest known soil release agents appear to be copolymers of polyethylene terephthalate-polyoxyethylene terephthalate (PET-POET), as disclosed in U.K. Patent Nos. 1,088,984 and 1,317,278. The ‘278 reference discloses the process of reacting spinning grade polyethylene terephthalate) with polyethylene glycol to form a copolymer useful for the treatment of polyester fiber fabric.

U.S. Pat. No. 3,962,152 (Nicol et al.) discloses the use of the nonionic soil release polymer comprising ethylene terephthalate and polyethylene oxide terephthalate in a detergent composition to improve cleaning. The inventive nonionic (copolyester) soil release polymers are claimed as having a molar ratio of ethylene terephthalate to polyethylene terephthalate of from about 25:75 to about 35:65, and a molecular weight range of from about 25,000 to about 55,000.

More recently, U.S. Pat. No. 5,786,318 (Blokzijl et al.) discloses a new soil release polymer comprising units of polyglycol or capped polyglycol, an aromatic dicarboxylic acid such as terephthalic acid and at least 30 mole % of a polyol having at least three hydroxyl groups, such as glycerol. Since the aromatic dicarboxylic acid may be sulfonated, such as sulfoisophthalic acid, these inventive soil release polymers may be nonionic or anionic in nature. The soil release polymers are incorporated into detergent compositions at 0.02 wt. % to 10 wt. %, including a concentrated powdered detergent.

U.S. Pat. Nos. 5,789,365, 5,789,366, and 5,789,367 (Blokzijl, et al.), disclose a laundry detergent composition containing water-soluble or water-dispersible sulfonated non-end-capped polyester as the soil release agent. The preferred inventive anionic polymers are comprised of terephthalic acid, isophthalic acid, sulfoisophthalic acid, and ethylene glycol, giving backbone units of formula —CO—Ar—CO₂—(CH₂CH₂O)ₙ—, where the Ar group represents terephthalic, isophthalic, and sulfoisophthalic residues. The example detergents that utilize the sulfonated non-end-capped polyester polymer as soil release agent include phosphate and zeolite/citrate built granular detergents.

U.S. Pat. No. 6,057,278 (Gosselink et al.) discloses the use of polyamines as cotton soil release polymers. The polyamines have modified backbones to improve the bleach stability of the polymers. The inventive polymers are zwitterionic in nature, having both positively charged quaternary amine groups and negatively charged ether sulfate groups. The inventive zwitterionic polymer, such as 4,9-dioxa-1,12-dodecanediamine that is ethoxylated, quaternized and sulfated, was used together with an anionic non-cotton soil release polymer (a sulfonated poly EO/PO end-capped ester oligomer) in a phosphated dry detergent composition.

U.S. Pat. Nos. 7,557,072 and 7,919,449 (Fütterer et al.) disclose the combination of an organophosphorous soil release agent and a non-cotton secondary soil release agent in a detergent composition for fabrics. The inventive organophosphorous compounds are nonionic or anionic in nature, depending if the phosphorous containing moiety is an ester or an acid.

Lastly, U.S. Pat. No. 7,939,601 (Bergeron, et al.) discloses a new polymer capable of carrying a cationic charge at a pH from 4 to 12, and the use of the new polymer as a soil release agent in a fabric cleaning composition. The polymer is preferably a terpolymer, such as poly(HEA-co-DMAM-co-AA), where HEA is hydroxyethylacrylate, DMAM is dimethylaminoethyl metacrylate, and AA is acrylic acid. The claim of interest is directed to the use of the polymer with at least one detergent surfactant and at least one member or a group of other detergent ingredients for washing a fabric article.

In spite of the multitude of prior art references disclosing the use of polymeric soil release agents, there is no teaching gleaned from any single reference, or from any combination of references, that guide one skilled in the art to choose which agents to use in any given situation, or whether blends of soil release agents may give unexpected boosts in performance.

### SUMMARY OF THE INVENTION

It has now been surprisingly found that a specific blend of at least two types of soil release polymers (e.g. SRN at x wt. %; SRA at y wt. %) show synergistic performance benefit in excess of the performance benefit measured from either soil release polymer (SRN or SRA) used singly at the same actives level as the blend (x+y wt. %).

In an exemplary embodiment of the present invention, the dosage (g/wash load) of dry detergent used in the washing machine may be reduced by about 20% if the dry detergent is formulated to include a synergistic blend of soil release polymers. That is, the detergent comprising the blend of soil release agents gives a cleaning performance at a reduced dosage level that is equal to or better than the performance measured for a larger dosage of conventional dry detergent that does not contain soil release agents.

In an exemplary embodiment of the present invention, a synergistic blend of at least one nonionic polymeric soil release agent (SRN) and at least one anionic polymeric soil release agent (SRA) may be used to boost the wash performance of a dry laundry detergent.

In a preferred embodiment of the present invention, a mixture comprising about 0.35 wt. % of a nonionic soil release polymer and 0.60 wt. % of an anionic soil release polymer boosts the whiteness maintenance of a dry detergent composition such that about 20% less detergent is required in the wash machine to achieve acceptable performance.

In another preferred embodiment of the present invention, a dry granular laundry detergent comprises:

a. at least one builder, such as a zeolite, silicate, and/or citrate;

b. at least one filler, such as a sulfate and/or chloride salt;

c. at least one alkaline agent, such as hydroxide, carbonate and/or bicarbonate;

d. at least one surfactant such as sodium dodecylbenzene sulfonate and/or alcohol alkoxylate; and,

e. a synergistic blend of soil release agents consisting essentially of one nonionic soil release agent (herein abbreviated SRN) and one anionic soil release agent (herein abbreviated SRA).

The present invention also includes a method for boosting the performance of a granular laundry detergent by adding a synergistic blend of an anionic and nonionic soil release polymers to said granular detergent.

### BRIEF DESCRIPTION OF THE DRAWINGS

FIG. 1 illustrates the soil release polymer blend whiteness maintenance effects measured on cotton and poly cotton fabrics.

### DETAILED DESCRIPTION OF THE INVENTION

The present invention is a dry laundry detergent composition containing a synergist blend of soil release polymers. The blend of soil release polymers gives a marked performance boost such that about 20% less of dry detergent need be used per load in the washing machine to achieve the same performance as the detergent without the soil release agents.

That said, one embodiment of the present invention is a dry granular laundry detergent composition comprising:

a. at least one builder;

b. at least one filler;

c. at least one alkaline agent;

d. at least one surfactant; and,

e. a synergistic blend of soil release agents, said blend consisting essentially of one nonionic soil release agent (SRN) and one anionic soil release agent (SRA).

In another embodiment of the present invention, the synergistic blend of nonionic and anionic polymeric soil release agents consists essentially of from about 0.1 wt. % to about 0.5 wt. % of nonionic agent and from about 0.1 wt. % to about 1.0 wt. % of anionic agent.

In yet another embodiment of the present invention, the synergistic blend of nonionic and anionic polymeric soil release agents consists essentially of from about 0.1 wt. % to about 0.5 wt. % of nonionic agent and from about 0.1 wt. % to about 1.0 wt. % of anionic agent, wherein the weight ratio of the nonionic agent to the anionic agent is near to 1:2. That is, in a preferred embodiment, there is about 1½ to about two times as much anionic soil release agent to nonionic soil release agent by weight in the dry granular laundry detergent of the present invention.

### Soil Release Agent Component

Polymeric soil release agents are synthetically manufactured polymers having a net overall anionic, cationic, or nonionic charge. Herein we abbreviate the nonionic soil release agents as “SRN” and the anionic soil release agents as “SRA.”

The preferred polymers for use in the present inventive composition include both the nonionic and anionic polymers. It is more preferred that one nonionic and one anionic polymer be used together as a polymeric blend in the laundry detergent compositions of the present invention. It is most preferred that from about 0.1 to about 0.5 wt. % actives nonionic SRN and from about 0.1 to about 1.0 wt. % anionic SRA be used together as a polymer blend in the present laundry detergent composition. The weight percentages (wt. %) recited here and throughout this application is the weight percent (wt. %) active material and is based on the total weight of the composition. In other words, the weight percentages of any given composition should total to 100%.

The ranges of the soil release agents disclosed herein are critical because when the two soil release agents are present together and incorporated within these ranges, an unexpected synergistic increase in whiteness maintenance is observed. More particularly, it is preferable that the anionic soil release agent be present at a level of about 1½ to about two times that of the nonionic soil release agent by weight, and most preferably at about 1.7 to 1 to about 2 to 1. That is, the weight ratio of nonionic SRN to anionic SRA should be about 1:1.7 up to about 1:2.0. Most preferred is to incorporate SRN at about 0.35 wt. % actives and SRA at about 0.60 wt. % actives, based on the total weight of the composition, with those preferable levels calculating to an SRN/SRA ratio of about 0.58.

The most preferred nonionic SRN for the present invention is based on polyethyleneterephthalate-polyoxyethyleneterephthalate co-polymers (so-called PET-POET), sold under the trade name TexCare® SRN by Clariant. The preferred polyester SRN's for use in the present invention include TexCare® SRN 100, TexCare® SRN 170, TexCare® SRN 240, TexCare® SRN 300, and TexCare® SRN 325, each available from Clariant. As mentioned, the nonionic soil release agent is preferably incorporated into the dry granular detergent composition of the present invention at from about 0.1 wt. % to about 0.5 wt. % actives, based on the total weight of the composition.

The most preferred anionic (SRA) soil release agents for use in the present invention include, but are not limited to, various sulfonate-capped, urethane-linked and/or carboxylate terminated polyester soil release agents. Useful anionic soil release polymers are also described in U.S. Pat. No. 4,721,580, WO 95/02028, WO 95/02029, EP 707 627, U.S. Pat. Nos. 5,691,298, 5,700,386, 5,843,878 and WO 96/18715, each incorporated herein by reference. Of particular use for the present invention is TexCare® SRA 300 and 300F from Clariant. The anionic soil release agent SRA is preferably used at from about 0.5 wt. % actives to about 1.0 wt. % actives based on the total weight of the composition. As mentioned the preferred ratio of SRA to SRN is from about 1.5 to about 2.0 to 1.

### Remaining Dry Detergent Components

Builders

The detergent composition of the present invention includes a builder. Such builders may include, but are not limited to, silicates, borates, zeolites, phosphates, citrates, and combinations thereof, at a level of from about 0.001% to about 50% by weight active material. More useful in the present invention is sodium, potassium, or magnesium, or mixed silicate, or combinations thereof.

The preferred silicate is an alkali metal silicate salt (the alkali metal salts of silicic acid) with the sodium and potassium silicate salts being the most preferred. The alkali metal silicates that are useful may be in a variety of forms that can be described by the general formula M₂O:SiO₂, wherein M represents the alkali metal and in which the ratio of the two oxides varies. Most useful alkali metal silicates will have a SiO₂/M₂O weight ratio of from about 1.6 to about 4. Preferred silicates include the Sodium Silicate Solutions from PQ Corporation, such as A®1647 Sodium Silicate Solution, a 46.8% active solution of sodium silicate having a SiO₂/Na₂O ratio of about 1.6 to about 1.8:1. Also of use in the compositions of the present invention are the potassium silicates, such as the Kasil® products from PQ Corporation. For example, Kasil®1 Potassium Silicate Solution is a 29.1% solution of potassium silicate having a SiO₂/K₂O ratio of about 2.5. It is preferable to use either sodium or potassium silicate at a level of from about 0.001% to about 1.0% in the compositions of the present invention. Also of use is sodium metasilicate and sodium silicate, such as the hydrous sodium silicate Britesil® C24 available from PQ Corporation. It is preferred to incorporate the silicate builder at from about 0.001 wt. % to about 50 wt. %, based on the total weight of the composition. Most preferred is to use a 1:1.8 sodium silicate at from about 5 wt. % to about 15 wt. %.

Alkaline Agent

It is preferred that the present composition include at least one alkaline agent. Such agents may participate in the neutralization of acidic ingredients during the processing of the detergent composition, and/or may provide extra alkalinity such that the pH of the wash machine liquor is greater than 7.0 when the wash machine is dosed with detergent and filled with water as a way to saponify greasy stains from fabric. Some of the usual in situ neutralizations expected between an alkaline agent and an acidic ingredient include, but are not limited to, neutralization of a sulfonic acid to a sulfonate salt, neutralization of an organic acid such as citric acid or a fatty acid to the corresponding carboxylate salt, and neutralization of a polyacrylic acid to the polyacrylate salt. The most common in situ neutralizations are sodium hydroxide and dodecylbenzene sulfonic acid combining to give sodium dodecylbenzene sulfonate, and neutralization of polyacrylic acid with sodium hydroxide to give sodium polyacrylate.

The alkaline agents that find use in the present composition include, but are not limited to, the alkali metal salts and alkaline earth salts of carbonate, bicarbonate, sesquicarbonate, and hydroxide. For example, sodium carbonate, sodium bicarbonate, sodium sesquicarbonate, potassium carbonate, potassium bicarbonate, potassium sesquicarbonate, sodium hydroxide, potassium hydroxide, magnesium hydroxide, lithium hydroxide, and the like, all find use in the present invention as the alkaline agent. Of course, any of these materials can be used together and in various amounts, particularly if one agent is used for in situ neutralization of an acidic component whilst another agent is added to provide alkalinity to the wash itself.

The alkaline agent(s) is/are incorporated at from about 0.1 wt. % actives to about 50 wt/% actives, based on the total weight of the composition. For example, an embodiment of the present dry granular detergent composition may comprise only about 2 wt. % sodium hydroxide but also about 30 wt. % sodium carbonate since the sodium hydroxide may be added first in the mixture to affect some neutralizations whereas the sodium carbonate is added as an alkalinity producing agent for during the wash.

Filler

Typical fillers found in dry granular laundry detergent compositions include sulfate salts and chloride salts. The choice is usually cost driven. Hence, the cheapest salt fillers tend to include sodium sulfate and sodium chloride. With that said, the preferred fillers for use in the present laundry detergent composition include alkali metal and alkaline earth salts of sulfate and/or alkali metal and alkaline earth salts of chloride. Most preferred are sodium sulfate, sodium chloride, and mixtures thereof Filler is incorporated at from about 1 wt. % to about 80 wt. %. An economy detergent may comprise at least about 60 wt. % filler whereas a more premium product may comprise less than about 40 wt. % filler.

Surfactants

Anionic Surfactants

The present composition preferably includes one or more anionic surfactants. Suitable anionic surfactants include the sulfonate and sulfate types. Preferred surfactants of the sulfonate type are C₉₋₁₃ alkylbenzenesulfonates, olefinsulfonates, hydroxyalkanesulfonates and disulfonates, as are obtained, for example, from C₁₂₋₁₈ monoolefins having a terminal or internal double bond by sulfonating with gaseous sulfur trioxide followed by alkaline or acidic hydrolysis of the sulfonation products. Anionic surfactants that are preferred for use in the present invention include the alkyl benzene sulfonate salts. Suitable alkyl benzene sulfonates include the sodium, potassium, ammonium, lower alkyl ammonium and lower alkanol ammonium salts of straight or branched-chain alkyl benzene sulfonic acids. Alkyl benzene sulfonic acids useful as precursors for these surfactants include decyl benzene sulfonic acid, undecyl benzene sulfonic acid, dodecyl benzene sulfonic acid, tridecyl benzene sulfonic acid, tetrapropylene benzene sulfonic acid and mixtures thereof. Preferred sulfonic acids, functioning as precursors to the alkyl benzene sulfonates useful for compositions herein, are those in which the alkyl chain is linear and averages about 8 to 16 carbon atoms (C₈-C₁₆) in length. Examples of commercially available alkyl benzene sulfonic acids useful in the present invention include Calsoft® LAS-99, Calsoft®LPS-99 or Calsoft®TSA-99 marketed by Pilot Chemical. Most preferred for use in the present invention is sodium dodecylbenzene sulfonate, available commercially as the sodium salt of the sulfonic acid, for example Calsoft® F-90, Calsoft® P-85, Calsoft® L-60, Calsoft® L-50, or Calsoft® L-40. Also of use in the present invention are the ammonium salts, lower alkyl ammonium salts and the lower alkanol ammonium salts of linear alkyl benzene sulfonic acid, such as triethanol ammonium linear alkyl benzene sulfonate including Calsoft® T-60 sold by Pilot Chemical. The preferred level of sulfonate surfactant in the present invention is from about 0.1% to about 50% by weight, based on the total weight of the composition. Most preferred is to use sodium dodecylbenzene sulfonate at a level of from about 0.1 wt. % to about 20 wt. % based on the total weight of the composition.

Also with respect to the anionic surfactants useful in the laundry detergent compositions herein, the alkyl ether sulfates, also known as alcohol ether sulfates, are preferred. Alcohol ether sulfates are the sulfuric monoesters of the straight chain or branched alcohol ethoxylates and have the general formula R-(CH₂CH₂O)ₓ—SO₃M, where R—(CH₂CH₂O)ₓ— preferably comprises C₇-C₂₁ alcohol ethoxylated with from about 0.5 to about 9 mol of ethylene oxide (x=0.5 to 9 EO), such as C₁₂-C₁₈ alcohols containing from 0.5 to 9 EO, and where M is alkali metal or ammonium, alkyl ammonium or alkanol ammonium counterion. Preferred alkyl ether sulfates include C₈-C₁₈ alcohol ether sulfates with a degree of ethoxylation of from about 0.5 to about 9 ethylene oxide moieties and most preferred are the C₁₂-C₁₅ alcohol ether sulfates with ethoxylation from about 4 to about 9 ethylene oxide moieties, with 7 ethylene oxide moieties being most preferred. It is understood that when referring to alkyl ether sulfates, these substances are already salts (hence designated “sulfonate”), and most preferred and most readily available are the sodium alkyl ether sulfates (also referred to as NaAES). Commercially available alkyl ether sulfates include the CALFOAM® alcohol ether sulfates from Pilot Chemical, the EMAL®, LEVENOL® and LATEMAL® products from Kao Corporation, and the POLYSTEP® products from Stepan, however most of these have fairly low EO content (e.g., average 3 or 4-EO). Alternatively the alkyl ether sulfates for use in the present invention may be prepared by sulfonation of alcohol ethoxylates (i.e., nonionic surfactants) if the commercial alkyl ether sulfate with the desired chain lengths and EO content are not easily found, but perhaps where the nonionic alcohol ethoxylate starting material may be. For example, sodium lauryl ether sulfate (“sodium laureth sulfate”, having about 3 ethylene oxide moieties) is very readily available commercially and quite common in shampoos and detersives, however, this is not the preferred level of ethoxylation for use in the present invention for surface cleaning. Therefore it may be more practical to sulfonate a commercially available nonionic surfactant such as Neodol® 25-7 Primary Alcohol Ethoxylate (a C₁₂-C₁₅/7EO nonionic from Shell) to obtain the C₁₂-C₁₅/7EO alkyl ether sulfate that may have been difficult to source commercially. The preferred level of C₁₂-C₁₈/0.5-9EO alkyl ether sulfate in the present invention is from about 0.1% to about 50%. Most preferred is from about 0.1% to about 20%.

Other anionic surfactants that may be included in the detersive composition herein include the alkyl sulfates, also known as alcohol sulfates. These surfactants have the general formula R—O—SO₃Na where R is from about 8 to 18 carbon atoms, and these materials may also be denoted as sulfuric monoesters of C₈-C₁₈ alcohols, examples being sodium n-octyl sulfate, sodium decyl sulfate, sodium palmityl alkyl sulfate, sodium myristyl alkyl sulfate, sodium dodecyl sulfate, sodium tallow alkyl sulfate, sodium coconut alkyl sulfate, and mixtures of these surfactants, or of C₁₀-C₂₀ oxo alcohols, and those monoesters of secondary alcohols of this chain length. Also useful are the alk(en)yl sulfates of said chain length which contain a synthetic straight-chain alkyl radical prepared on a petrochemical basis, these sulfates possessing degradation properties similar to those of the corresponding compounds based on fatty-chemical raw materials. From a detersives standpoint, C₁₂-C₁₆-alkyl sulfates, C₁₂-C₁₅-alkyl sulfates, and also C₁₄-C₁₅ alkyl sulfates, are all preferred. Most preferred is to use sodium lauryl sulfate from the Stepan Company sold under the trade name of Polystep®. The preferred level of alcohol sulfate in the present invention is from about 0.1 wt. % to about 50 wt. %. Most preferred is from about 0.1 wt. % to about 20 wt. %.

Fatty soaps may also be incorporated into the laundry detergent composition as an anionic surfactant component as these are particularly suitable to aid in fat and grease removal and as a defoamer. As used here, “fatty soap” means the salts of fatty acids. For example, the fatty soaps that may be used here have general formula R—CO₂M, wherein R represents a linear or branched alkyl or alkenyl group having between about 8 and 24 carbons and M represents an alkali metal such as sodium or potassium or ammonium or alkyl- or dialkyl- or trialkyl-ammonium or alkanol-ammonium cation. The fatty acid soaps suitable for emulsifying fats from fabric, is preferably comprised of higher fatty acid soaps. That fatty acids that may be the feed stock to the fatty soaps may be obtained from natural fats and oils, such as those from animal fats and greases and/or from vegetable and seed oils, for example, tallow, hydrogenated tallow, whale oil, fish oil, grease, lard, coconut oil, palm oil, palm kernel oil, olive oil, peanut oil, corn oil, sesame oil, rice bran oil, cottonseed oil, babassu oil, soybean oil, castor oil, and mixtures thereof. Fatty acids can be synthetically prepared, for example, by the oxidation of petroleum, or by hydrogenation of carbon monoxide by the Fischer-Tropsch process. The fatty acids of particular use in the present invention are linear or branched and containing from about 8 to about 24 carbon atoms, preferably from about 10 to about 20 carbon atoms and most preferably from about 14 to about 18 carbon atoms. Preferred fatty acids for use in the present invention are tallow or hydrogenated tallow fatty acids and their preferred salts (soaps) are alkali metal salts, such as sodium and potassium or mixtures thereof. Other useful soaps are ammonium and alkanol-ammonium salts of fatty acids. The fatty acids that may be included in the present compositions will preferably be chosen to have desirable surface cleaning efficacy and foam regulation. Of course, the fatty acids may be added as the free acids that are neutralized in situ in the composition by the various alkaline agents. The preferred level of fatty soap in the present invention is from about 0.1 wt. % to about 50 wt. %. Most preferred is from about 0.1 wt. % to about 20 wt. %.

Additional anionic surfactants that may fmd use in the compositions of the present invention include the alpha-sulfonated alkyl esters of C₁₂-C₁₆ fatty acids. The alpha-sulfonated alkyl esters may be pure alkyl ester or a blend of (1) a mono-salt of an alpha-sulfonated alkyl ester of a fatty acid having from 8-20 carbon atoms where the alkyl portion forming the ester is straight or branched chain alkyl of 1-6 carbon atoms and (2) a di-salt of an alpha-sulfonated fatty acid, the ratio of mono-salt to di-salt being at least about 2:1. The alpha-sulfonated alkyl esters useful herein are typically prepared by sulfonating an alkyl ester of a fatty acid with a sulfonating agent such as SO₃. When prepared in this manner, the alpha-sulfonated alkyl esters normally contain a minor amount, (typically less than 33% by weight), of the di-salt of the alpha-sulfonated fatty acid which results from saponification of the ester. Preferred alpha-sulfonated alkyl esters contain less than about 10% by weight of the di-salt of the corresponding alpha-sulfonated fatty acid.

The alpha-sulfonated alkyl esters, i.e., alkyl ester sulfonate surfactants, include linear esters of C₆-C₂₂ carboxylic acids that are sulfonated with gaseous SO₃. Suitable starting materials preferably include natural fatty substances as derived from tallow, palm oil, etc., rather than from petroleum sources. The preferred alkyl ester sulfonate surfactants, especially for a detersive composition for the present invention, comprise alkyl ester sulfonate surfactants of the structural formula R³—CH(SO₃M)-CO₂R⁴, wherein R³ is a C₈-C₂₀ hydrocarbon chain preferably naturally derived, R⁴ is a straight or branched chain C₁-C₆ alkyl group and M is a cation which forms a water soluble salt with the alkyl ester sulfonate, including sodium, potassium, magnesium, and ammonium cations. Preferably, R³ is C₁₀-C₁₆ fatty alkyl, and R⁴ is methyl or ethyl. Most preferred are alpha-sulfonated methyl or ethyl esters of a distribution of fatty acids having an average of from 12 to 16 carbon atoms. For example, the alpha-sulfonated esters Alpha-Step® BBS-45, Alpha-Step® MC-48, and Alpha-Step® PC-48, all available from the Stepan Co. of Northfield, Ill., may find use in the present invention. Alpha-sulfonated fatty acid ester surfactants may be used at a level of from about 0.1% to about 5% and most preferably at a level of from about 0.1% to about 2% by weight in the detersive composition.

Nonionic Surfactants

The detergent composition of the present invention preferably includes a nonionic surfactant such as an alcohol alkoxylate, alkyl polyglycoside, alkoxylated ester, or fatty acid amide, or any mixture thereof.

Preferred for use as the nonionic surfactant in the present compositions are the alkyl polyglycoside surfactants. The alkyl polyglycosides (commonly referred to as APG's), also called alkyl polyglucosides if the saccharide moiety is glucose, are naturally derived, nonionic surfactants. The alkyl polyglycosides that may be used in the present invention are fatty ester derivatives of saccharides or polysaccharides, formed when a carbohydrate is reacted under acidic conditions with a fatty alcohol through condensation polymerization. The APG's are typically derived from corn-based carbohydrates and fatty alcohols from natural oils found in animals, coconuts and palm kernels. Such methods for deriving APG's are well known in the art. The alkyl polyglycosides that are preferred for use in the present invention contain a hydrophilic group derived from carbohydrates and is composed of one or more anhydroglucose units. Each of the glucose units may have two ether oxygen atoms and three hydroxyl groups, along with a terminal hydroxyl group, which together impart water solubility to the glycoside. The presence of the alkyl carbon chain leads to the hydrophobic tail of the molecule.

When carbohydrate molecules react with fatty alcohol compounds, alkyl polyglycoside molecules are formed having single or multiple anhydroglucose units, which are termed monoglycosides and polyglycosides, respectively. The final alkyl polyglycoside product typically has a distribution of glucose units (i.e., degree of polymerization).

The APG's that may be used in the present invention preferably comprise saccharide or polysaccharide groups (i.e., mono-, di-, tri-, etc. saccharides) of hexose or pentose, and a fatty aliphatic group having 6 to 20 carbon atoms. Preferred alkyl polyglycosides that can be used according to the present invention are represented by the general formula, Gₓ-O—R¹, wherein G is a moiety derived from reducing saccharide containing 5 or 6 carbon atoms, e.g., pentose or hexose; R¹ is fatty alkyl group containing 6 to 20 carbon atoms; and x is the degree of polymerization of the polyglycoside, representing the number of monosaccharide repeating units in the polyglycoside. Generally, x is an integer on the basis of individual molecules, but because there are statistical variations in the manufacturing process for APG's, x may be a non-integer on an average basis when referred to particular APG's of use as an ingredient for the detersive composition of the present invention. For the APG's preferred for use herein, x preferably has a value of less than 2.5, and more preferably is between 1 and 2. Exemplary saccharides from which G can be derived are glucose, fructose, mannose, galactose, talose, gulose, allose, altrose, idose, arabinose, xylose, lyxose and ribose. Because of the ready availability of glucose, glucose is preferred in polyglycosides. The fatty alkyl group is preferably saturated, although unsaturated fatty chains may be used. Generally, the commercially available polyglycosides have C₈ to C₁₆ alkyl chains and an average degree of polymerization of from 1.4 to 1.6.

Commercially available alkyl polyglycoside can be obtained as concentrated aqueous solutions ranging from 50 to 70% actives and are available from Cognis. Most preferred in the present compositions are APG's with an average degree of polymerization of from 1.4 to 1.7 and the chain lengths of the aliphatic groups are between C₈ and C₁₆. For example, one preferred APG for use herein has chain length of C₈ and C₁₀ (ratio of 45:55) and a degree of polymerization of 1.7. The laundry detergent composition preferably includes a sufficient amount of alkyl polyglycoside surfactant in an amount that provides a desired level of cleaning of soils from fabrics. Preferably, the laundry detergent composition includes between about 0.1% and about 5% by weight alkyl polyglycoside surfactant and more preferably APG® 325N or Glucopon® 215 from Cognis at between about 0.1% and 5.0% by weight active alkyl polyglucoside surfactant to the total aqueous composition.

Also useful in the laundry detergent composition of the present invention are alkoxylated alcohols such as the ethoxylated and/or propoxylated primary alcohols having 10 to 18 carbon atoms and on average from 4 to 12 moles of ethylene oxide (EO) and/or from 1 to 10 moles of propylene oxide (PO) per mole of alcohol. Further examples are alcohol ethoxylates containing linear radicals from alcohols of natural origin having 12 to 18 carbon atoms, e.g., from coconut, palm, tallow fatty or oleyl alcohol and on average from 4 to about 12 EO per mole of alcohol. Somewhat useful as a nonionic surfactant in the present invention is the C₁₄-C₁₅ alcohol ethoxylate-7EO and the C₁₂-C₁₄ alcohol ethoxylate-12EO incorporated from about 1% to about 70%, for example at a level of from about 1% to about 20%. Nonionic ethoxylate surfactants that may find use herein include for example, Neodol® 45-7, Neodol® 25-9, or Neodol® 25-12 from Shell Chemical Company. Most preferred are Neodol® 45-7, which is a C₁₄-C₁₅ alcohol ethoxylate-7EO and Neodol® 25-9, available from Shell, which is a C₁₂-Cᵢₛ alcohol ethoxylate-9EO surfactant. Combinations of more than one alcohol ethoxylate surfactant may also be desired in the detersive composition in order to maximize removal of various soils from various types of fabrics and fabric blends. Alcohol ethoxylate nonionic surfactants are preferably incorporated at a level of from about 0.1% to about 10% by weight and most preferably from about 0.1% to about 2.0% by weight in the total dry granular composition. Since many of these materials are liquids at room temperature, they are preferably sprayed onto a base bead material in a ribbon blender or suitable mixer.

Lastly, the laundry detergent composition of the present cleaning system may also include an amide type nonionic surfactant, for example alkanolamides that are condensates of fatty acids with alkanolamines such as monoethanolamine (MEA), diethanolamine (DEA) and monoisopropanolamine (MIPA), that have found widespread use in detergent formulations. Useful alkanolamides include ethanolamides and/or isopropanolamides such as monoethanolamides, diethanolamides and isopropanolamides in which the fatty acid acyl radical typically contains from 8 to 18 carbon atoms. Especially satisfactory alkanolamides have been mono- and diethanolamides such as those derived from coconut oil mixed fatty acids or special fractions containing, for instance, predominately C₁₂ to C₁₄ fatty acids. For most applications, alkanolamides prepared from trialkylglycerides are considered most practical due to lower cost, ease of manufacturing and acceptable quality. Of use in the present invention are mono- and diethanolamides derived from coconut oil mixed fatty acids, (predominately C₁₂ to C₁₄ fatty acids), such as those available from McIntyre under the brand name Mackamide®. Most preferred is Mackamide® CMA, which is coconut monoethanolamide available from McIntyre. If used, the amide surfactants are preferably incorporated at a level of from about 0.1% to about 10% and most preferably from about 0.1% to about 2% by weight in the dry composition.

Adjuvant

The present composition may include a number of ingredients typically found in dry granular detergent compositions, referred to herein as “adjuvant.” Such materials may be selected from the group consisting of water, solvents, hypochlorite bleach and/or peroxide oxidants, persulfate, perborate, or percarbonate salts, soil dispersing/crystal growth modifying polymers such as 4500 MW polyacrylate, anti-caking additives, fragrance, dyes, chelants, antimicrobial preservatives, antioxidants, uv light absorbents, florescent whitening agents, bluing agents, and mixtures thereof.

### Exemplary Embodiments of the Present Invention and Demonstration of Unexpected Synergistic Effects from a Blend of SRN and SRA

Referring now to TABLE 1 and FIG. 1 together, four laundry detergent formulations were used to wash both cotton and poly/cotton fabric. The washed fabrics were then evaluated for whiteness maintenance using an industry standard test method. The data is reported in both the table and the figure as percent (%) whiteness maintenance. Larger numbers indicate greater whiteness maintained after washing of the test fabrics, and hence better performance. The control composition for this test was Formulation 1, formulated to have no polymeric soil release agents at all. This composition gave 98.68% whiteness maintenance on poly/cotton blend fabric and 99.31% whiteness maintenance on cotton fabric when dosed at 33 g in the test washing machine. For an “economical” wash, or in other words a “reduced cost” wash, the dose was lowered to 26 g in the test washing machine. Such a lowered performance would also be likely from a hypothetical composition having more filler and fewer actives and still dosed at 33 g/load. As expected, the resulting performance dropped as indicated in the table to 91.96% and 98.41% respectively. Three additional formulations were produced as indicated in the table as Formulations 2, 3, and 4. These have the nonionic soil release agent (SRN) alone, the anionic soil release agent (SRA) alone, and a combination of both SRN and SRA, respectively. As indicated by the % whiteness maintenance values in the table, the combination of polymeric soil release agents, in particular the combination of nonionic and anionic agents raises the performance of the reduced dosage wash back to, and even slightly exceeding, the performance seen for the base Formulation 1 at the higher dose level of 33 g/wash. Most importantly, SRN or SRA used singly cannot give the performance seen by the combination of the two. The prior art is absent any teaching that this particular combination of 0.35 wt. % nonionic soil release agent and 0.60 wt. % anionic soil release agent is predicted to give such superior whiteness maintenance performance. Furthermore, the combination of nonionic and anionic soil release agents seems to boost the performance on cotton fabrics, which is unusual and unpredicted since standard nonionic and anionic soil release agents, like the substances used herein, typically do not alter the performance of laundry detergents on cotton fabrics.

The present invention also includes a method of increasing the performance of a dry laundry detergent comprising builder, alkaline agent, surfactant and filler, said method comprising the step of adding a blend of soil release agents consisting essentially of a nonionic agent and an anionic agent to said dry laundry detergent.

TABLE 1
Exemplary Granular Detergent Compositions

| | Formulations | | | | |
|---|---|---|---|---|---|
| Ingredients (wt. % actives) | 1 | | 2 | 3 | 4 |
| Sodium carbonate | 40 | | 40 | 40 | 40 |
| Sodium bicarbonate | — | | — | — | — |
| Sodium sesquicarbonate | — | | — | — | — |
| Sodium silicate | 10 | | 10 | 10 | 10 |
| Sodium citrate | — | | — | — | — |
| Na₂SO₄ or NaCl filler | 30 | | 29 | 29 | 29 |
| Dodecylbenzene sulfonic acid | 10 | | 10 | 10 | 10 |
| Sodium alkyl ether sulfate | — | | — | — | — |
| Fatty acid | — | | — | — | — |
| C₁₂-C₁₅ Alcohol ethoxylate- | 5 | | 5 | 5 | 5 |
| 9EO | | | | | |
| Zeolite | 0 to 1 | | 0 to 1 | 0 to 1 | 0 to 1 |
| Sodium polyacrylate | 0 to 2 | | 0 to 2 | 0 to 2 | 0 to 2 |
| 4500 MW | | | | | |
| Percarbonate, perborate or | 0 to 2 | | 0 to 2 | 0 to 2 | 0 to 2 |
| persulfate | | | | | |
| Nonionic SRN¹ | 0 | | 0.70 | 0 | 0.35 |
| Anionic SRA² | 0 | | 0 | 1.2 | 0.60 |
| Perfume, water, adjuvant | q.s. | | q.s. | q.s. | q.s. |
| Total | 100 | | 100 | 100 | 100 |
| Dosage in wash machine | 33 g | 26 g | 26 g | 26 g | 26 g |
| per load | | | | | |
| Performance | | | | | |
| Whiteness Maintenance | 98.68 | 91.96 | 97.90 | 95.75 | 98.98 |
| Poly/cotton | | | | | |
| Whiteness Maintenance | 99.31 | 98.41 | 97.45 | 98.73 | 99.44 |
| Cotton | | | | | |

Table Notes:
¹Nonionic polymeric soil release agent: Repel-O-Tex® SRP-6, from Rhodia; Texcare® SRN-400 from Clariant; Texcare® 240N from Clariant; or Texcare® SRN-300 from Clariant.
²Anionic polymeric soil release agent: Texcare® SRA-100, from Clariant; or Texcare® SRA-300F, from Clariant.

I claim:

1. A dry granular detergent composition comprising:
a) from about 0.001 wt. % to about 50 wt. % of a builder selected from the group consisting of zeolite, citrate, phosphate, silicate, and mixtures thereof;
b) from about 1 wt. % to about 80 wt. % of a filler selected from the group consisting of sulfate salts, chloride salts, and mixtures thereof;
c) from about 0.1 wt. % to about 50 wt. % of an alkaline agent selected from the group consisting of carbonates, bicarbonates, sesquicarbonates, hydroxides, and mixtures thereof;
d) from about 0.1 wt. % to about 20 wt % of at least one surfactant selected from the group consisting of anionic surfactants, nonionic surfactants, and mixtures thereof; and
e) a synergistic blend of polymeric soil release agents, said blend consisting essentially of i) from about 0.1 wt. % to about 0.5 wt. % of a nonionic soil release agent, and ii) from about 0.1 wt. % to about 1.0 wt. % of an anionic soil release polymer; and
wherein the weight ratio of said anionic soil release agent to said nonionic soil release agent is from about 1.7 to about 2.0.

2. The composition of claim 1, wherein said at least one surfactant comprises a mixture of dodecylbenzene sulfonate and C₁₂-C₁₅/9EO alcohol ethoxylate.

3. The composition of claim 1, wherein said nonionic soil release agent is a polyester consisting of polyethylene terephthalate and polyoxyethylene terephthalate.

4. The composition of claim 1, wherein said anionic soil release agent is chosen from the group consisting of sulfonated polyester, end-capped sulfonated polyester, carboxylate terminated polyester, and mixtures thereof.

5. A method of boosting the whiteness maintenance performance of a dry granular laundry detergent consisting essentially of builder, filler, alkaline agent, and surfactant, said method comprising the steps of:
a) Preparing said detergent by combining said builder, filler, alkaline agent and surfactant; and
b) Adding to said detergent a synergistic blend of polymeric soil release agents, said blend consisting essentially of (i) a nonionic soil release agent; and (ii) an anionic soil release agent, wherein the weight ratio of said nonionic agent to said anionic agent is from about 1:1.5 to about 1:2.0.

6. A dry granular laundry detergent consisting essentially of hydroxide, silicate, zeolite, carbonate, dodecylbenzene sulfonate, alcohol ethoxylate, filler, nonionic soil release agent, and anionic soil release agent, wherein the weight ratio of said nonionic soil release agent to said anionic soil release agent is from about 1:1.5 to about 1:2.0.
